(19) United States
(12) Patent Application Publication
(10) Pub. No.: US 2008/0249712 A1
(43) Pub. Date: Oct. 9, 2008

(54) Portable Navigation Device

(76) Inventor: Chung-Yuan Wang, Ciaotou Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/060,312

(22) Filed: Apr. 1, 2008

(30) Foreign Application Priority Data
Apr. 3, 2007 (TW) 096205428

(51) Int. Cl. G01C 21/36

(52) U.S. Cl. 701/210; 701/200; 701/208

(57) ABSTRACT

A portable navigation device comprises a GPS module severing to receive the positioning signals transmitted from satellites; a data manipulation module serving to process the positioning signal received from the GPS module, and at least including a central process unit and a database, the central process unit being coupled to the GPS module, and the database severing to store the information of map, navigation software; an operating module being coupled with the central process unit, and including a panel for setting the navigation data of the destination and the functions of the navigating software; a projection module being coupled with the central process unit, and including a head up display for displaying the mobile information of a vehicle in a common mode or the easy navigation information in a navigation mode, and then the mobile or the navigation information being projected onto the projection member of a windshield glass of the vehicle.

### BACKGROUND OF THE INVENTION

1. Field of the Invention

The present invention relates to a navigation device, and more particularly to a portable navigation device that may display the mobile information or the easy navigation onto a windshield glass of a vehicle in a common mode or a navigation mode alternatively, and show the auxiliary navigation information, such as an about-to-turn road name, in a voice indication manner.

2. Description of the Prior Art

Global Positioning System is widely used in modern technologies increasingly, such as positioning or navigation function in driving a car. The two most popular navigation devices include a portable PDA in a small size and a build-in device fixed in a vehicle. However such two devices still have the following disadvantages.

1. The size of a screen provided in the portable PDA or the build-in device is too small to display the map clearly, failing to distinguish the path and road name well.

2. The navigation device is mounted at the same height as the instrument panel, therefore the driver has to lower his head to watch the navigation information, causing a danger during driving.

U.S. patent application Ser. No. 11/738,467 (TW Publication No. 095215441) discloses a global positioning device with a HUD may provide a head-up display function so as to obtain the mobile information without raising head during driving. Nevertheless, such a prior art positioning device may only provide limited information, e.g. the driving speed, direction, and time but not provide the navigation information.

The present invention has arisen to mitigate and/or obviate the afore-described disadvantages.

### SUMMARY OF THE INVENTION

The primary object of the present invention is to provide a portable navigation device that may project the easy navigation information, e.g. driving forward directly, making a left turn, making a right turn, and the like turning symbols or distance numbers to the predetermined position of the windshield glass for being read by the driver directly. On the other hand, the is auxiliary navigation information, such as the about-to-turn road name may be heard by the driver in a voice manner, maintaining the driver's attention.

A further object of the present invention is to provide a portable navigation device that may display navigation information or mobile information by switching double modes alternatively. For example, the navigation information is projected in a navigation mode easily, and the navigation mode is switched to a common mode automatically for providing the mobile information of the vehicle, e.g. coordinates of longitude and latitude, height, driving direction and speed, and the like positioning information. In addition, the mobile information is transmitted to and shared with other wireless devices by matching with the wireless transceiver module.

Another object of the present invention is to provide a portable navigation device that may be portable and installed easily.

In accordance with one aspect of the present invention, there is provided a portable navigation device comprising

a GPS module being provided to receive the positioning signals which are transmitted from satellites;

a data manipulation module being used to process the positioning signals received from the GPS module, and at least including a central process unit and a database, the central process unit being coupled to the GPS module, and the database being applied to store the information of map, navigation software;

an operating module being coupled with the central process unit, and including a panel for setting the navigation data of the destination and the functions of the navigating software;

a projection module being coupled with the central process unit, and including a head up display for displaying the mobile information of a vehicle in a common mode or the easy navigation information in a navigation mode, and then the mobile or the navigation information being projected onto the projection member of a windshield glass of the vehicle.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a plan diagram showing the operation of a portable navigation device in accordance with a first embodiment of the present invention;

FIG. 2 is a block diagram illustrating the structure of the portable navigation device in accordance with the first embodiment of the present invention;

FIG. 3 is a plan diagram illustrating the portable navigation device of the present invention being used in driving;

FIG. 4A is a block diagram illustrating the structure of a portable navigation device in accordance with a second embodiment of the present invention;

FIG. 4B is another block diagram illustrating the structure of the portable navigation device in accordance with the second embodiment of the present invention;

FIG. 5 is a plan diagram showing the operation of the portable navigation device in accordance with the second embodiment of the present invention;

FIG. 6A is a block diagram illustrating the structure of a portable navigation device in accordance with a third embodiment of the present invention;

FIG. 6B is another diagram illustrating the structure of the portable navigation device in accordance with the third embodiment of the present invention;

FIG. 7 is a plan diagram showing the operation of the portable navigation device in accordance with the third embodiment of the present invention;

FIG. 8A is a block diagram illustrating the structure of a portable navigation device in accordance with a fourth embodiment of the present invention;

FIG. 8B is another block diagram illustrating the structure of the portable navigation device in accordance with the fourth embodiment of the present invention.

### DETAILED DESCRIPTION OF THE PREFERRED EMBODIMENTS

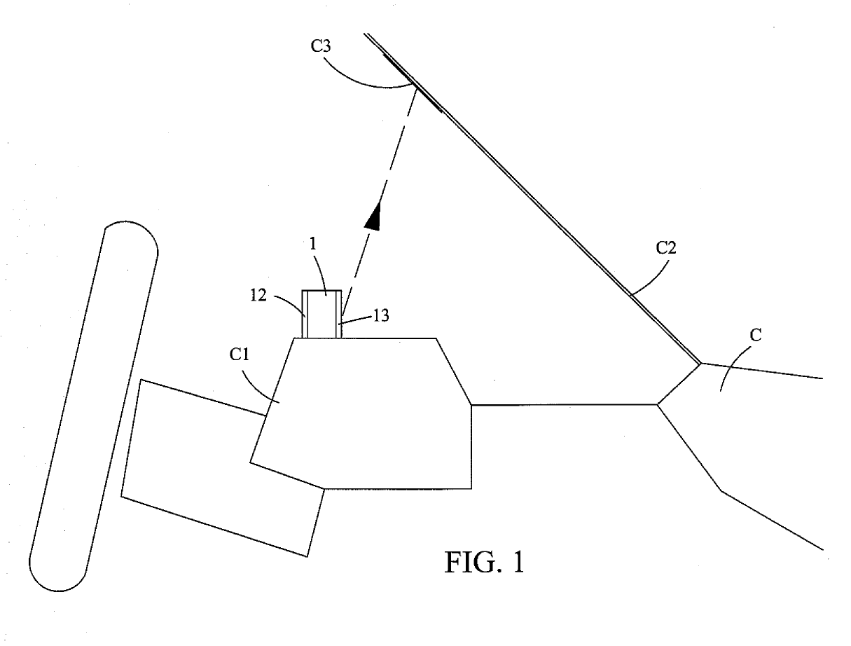

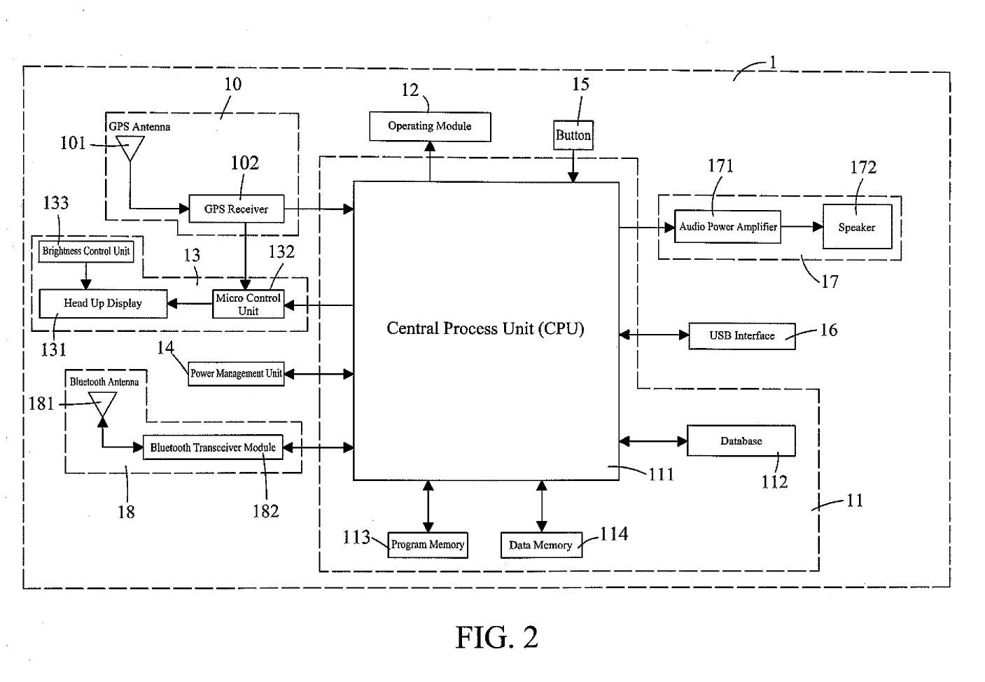

Referring to FIGS. 1 and 2, a portable navigation device in accordance with a first embodiment of the present invention is received in a first housing 1 which is disposed onto a instrument panel C1 of a vehicle C in place, and comprises a GPS module 10, a data manipulation module 11, an operating module 12, a projection module 13, a power management unit 14, at least one button 15, a USB interface 16, an indication unit 17, a wireless transceiver module 18, and a projection member C3 adhered onto a windshield glass C2, wherein

the GPS module 10 is provided to receive the positioning signals which are transmitted from satellites, and includes a GPS antenna 101 for receiving satellite signals and a GPS receiver 102. The mobile information of the vehicle contains coordinates of longitude and latitude, height, driving direction and speed, and the like positioning information.

The data manipulation module 11 is used to process the positioning signals received from the GPS module 10, and includes a central process unit (CPU) 111, a database 112, a program memory 113, and a data memory 114. The central process unit 111 is coupled to the GPS module 10, and the database 112 is applied to store the information of map, navigation software, and the like data and is stored in a removable storage card (not shown) so as to update data. The central process unit 111 is further coupled with a read interface (not shown), so as to read the data stored in the database 112 of the removable storage card. The program memory 113 is coupled to a flash memory of the central process unit 111, and the data memory 114 is a SDRAM memory coupled to the central process unit 111 as well.

The operating module 12 is coupled with the central process unit 111, and includes a touch panel for setting the navigation data of the destination and the functions of the navigating software. Moreover, the operating module 12 is fixed on one side of the first housing 1 opposite to the driver.

The projection module 13 is attached on another side of the first housing 1 opposite to the windshield glass C2 and coupled with the central process unit 111, and includes a head up display 131, a micro control unit (MCU) 132 and a brightness control unit 133 so as to display the mobile information of the vehicle in a common mode or the easy navigation information in a navigation mode, and the mobile or the navigation information is projected onto the projection member C3 of the windshield glass C2 of the vehicle C. The mobile information of the vehicle in the common mode involves the coordinates of longitude and latitude, height, driving direction and speed, and the like positioning information. Yet in the navigation mode, the easy navigation information contains driving forward directly, making a left turn, making a right turn, and the like turning symbols or distance numbers. The micro control unit 132 transmits the mobile information or the easy navigation information to the head up display 131 through the central process unit 111 and controls the head up display 131 to output elements. The brightness control unit 133 serves to sense the environment brightness and then to control the brightness of the head up display 132 automatically.

The power management unit 14 is coupled with the central process unit 111 as well, and includes at least one chargeable battery for controlling the operation of the circuit of the portable navigation device, such as standby, power supply, and charge, etc.

The button 15 is coupled to the central process unit 111 for starting and controlling the portable navigation device.

The USB interface 16 is coupled with the central process unit 111 for connecting with a computer and for charging batteries.

The indication unit 17 is coupled with the central process unit 111 for indicating the auxiliary navigation information to the driver in a voice manner in the navigation mode, and the auxiliary navigation information contains an about-to-turn road name, the indication unit 17 includes an audio power amplifier 171 and a speaker 172, such that the auxiliary navigation information is outputted from the speaker 172, and the audio power amplifier 171 amplifies the voice signals for being outputted from the speaker 172.

The wireless transceiver module 18 is coupled with the central process unit 111 for transmitting the positioning signals of the satellites to other wireless devices or for transmitting the voice navigation information to a wireless earphone wore by the driver, and includes a bluetooth antenna 181 and a bluetooth transceiver 182.

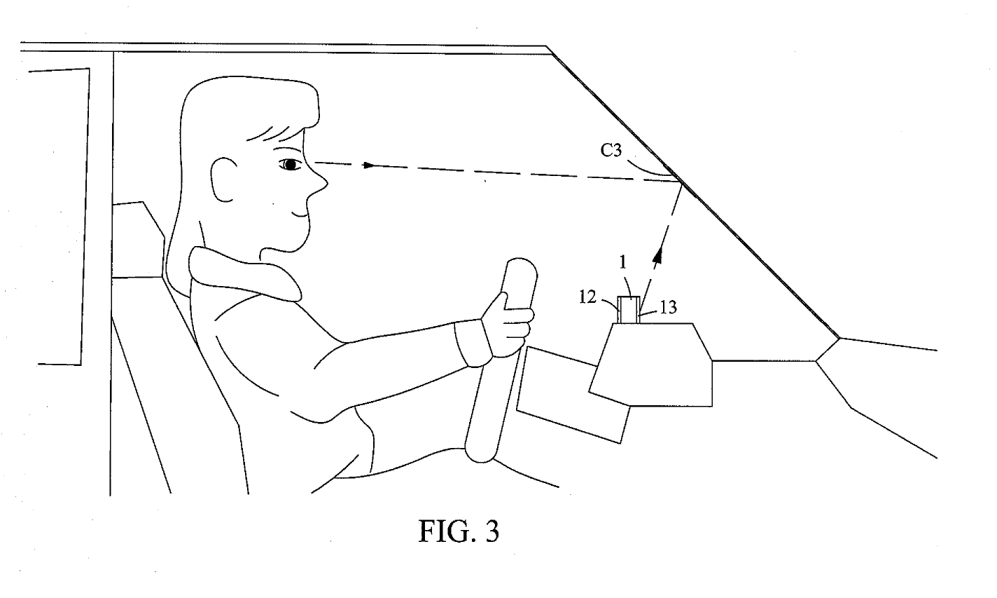

The projection member C3 is adhered at a predetermined position of the windshield glass C2 so that the information may be projected thereon, such that the driver may read the massage horizontally (as shown in FIG. 3) without lowering her head, enhancing the driving safety.

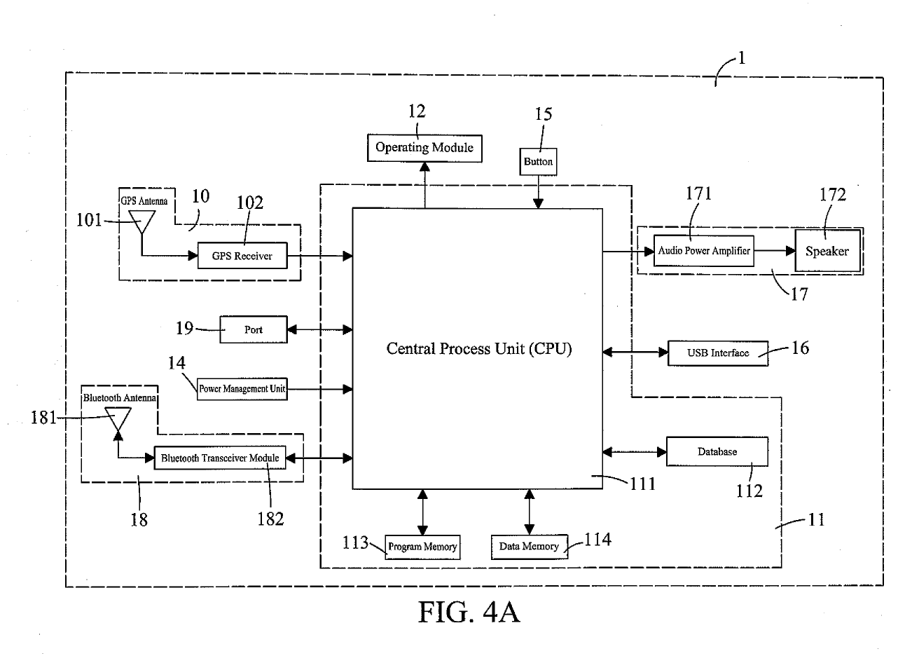

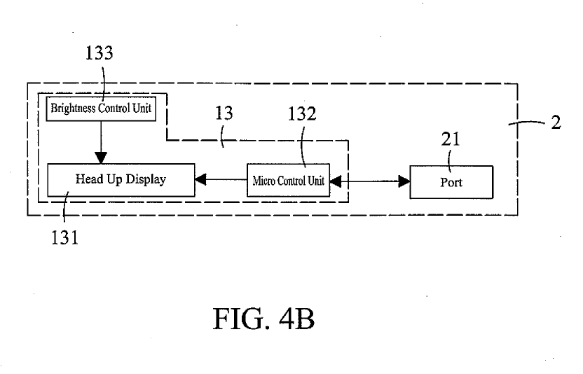

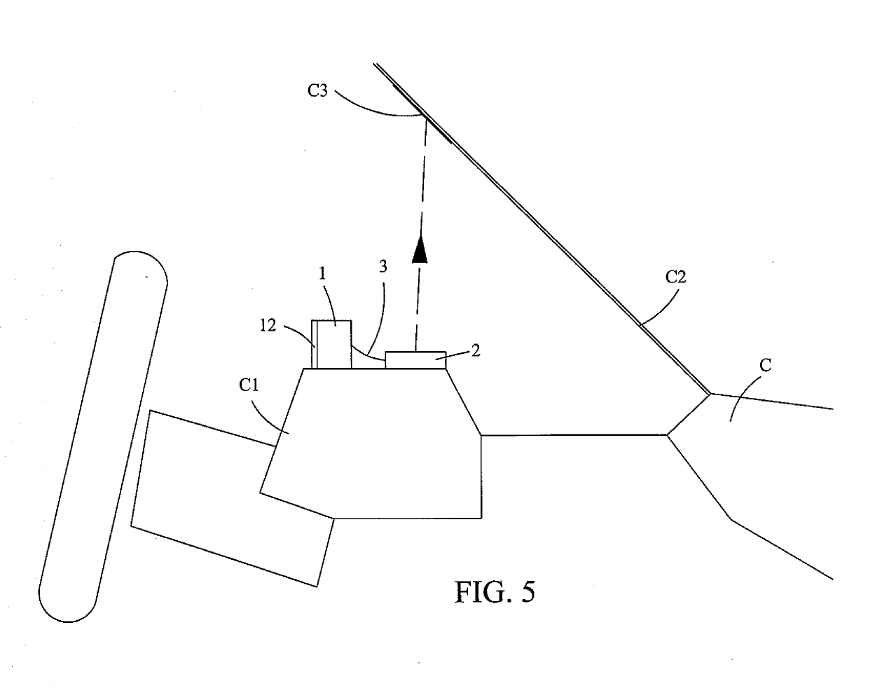

Referring to FIGS. 4A, 4B, and 5, a portable navigation device in accordance with a second embodiment of the present invention includes the projection module 13 received in a second housing 2 independently from other modules received in the first module 1. The first and second housings 1 and 2 include ports 19 and 21 respectively for connecting with a connecting cord 3, such that the mobile or the navigation information is transmitted to the projection member C3 of the windshield glass C2 through the connecting cord 3.

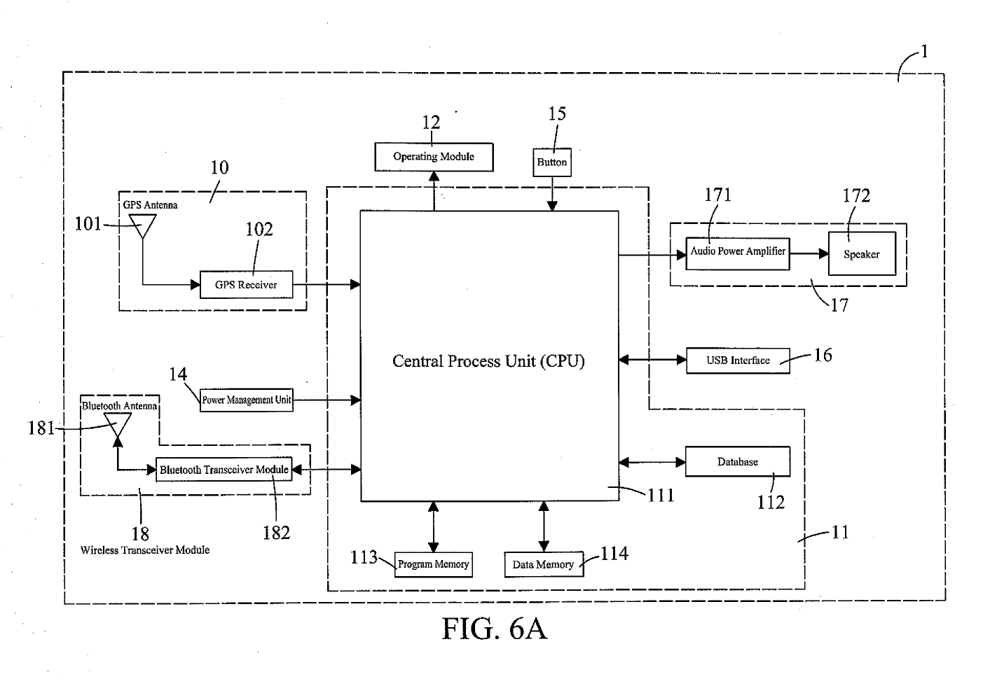

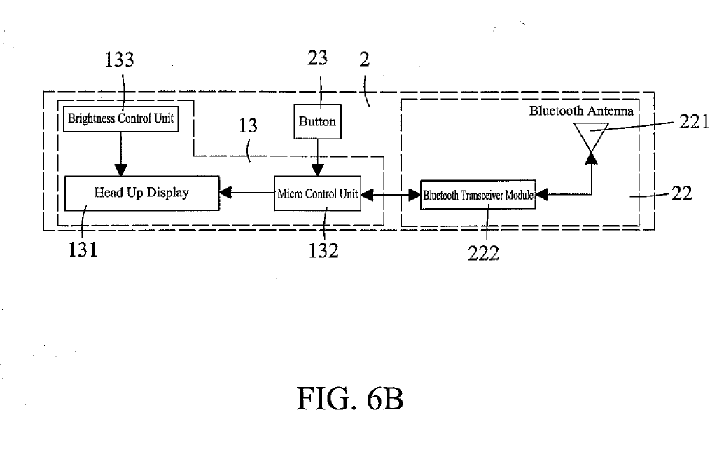

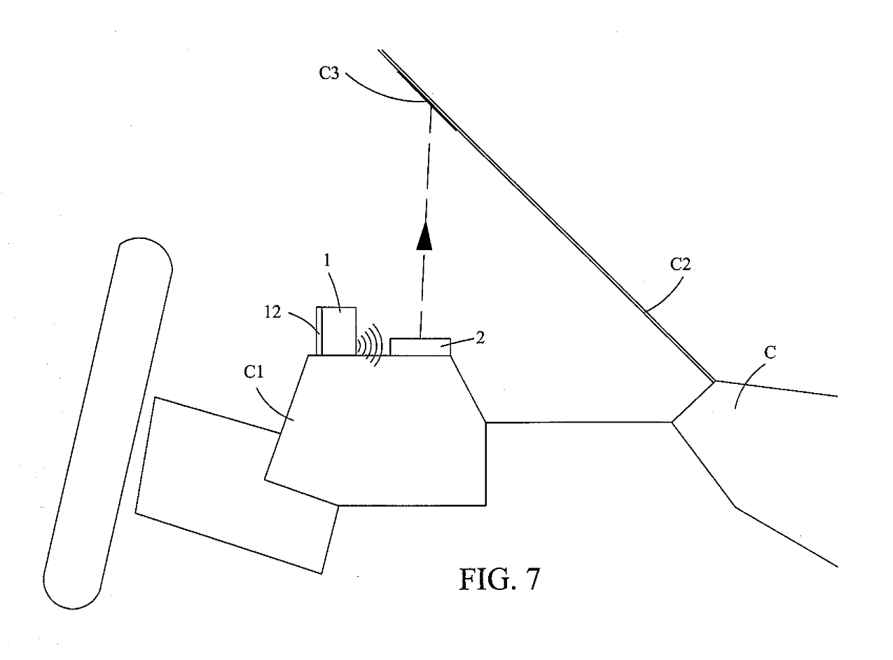

As illustrated in FIGS. 6A, 6B, and 7, a portable navigation device according to a third embodiment of the present invention comprises the projection module 13 received in the second housing 2 independently from other modules received in the first housing 1. The second housing 2 includes a wireless transceiver module 22 in response to the wireless transceiver module 18 of the first housing 1, and includes a bluetooth antenna 221 and a bluetooth transceiver module 222 so that the mobile or navigation information is transmitted to the projection module 13 through the wireless transceiver module 18 of the first housing 1, and then is projected onto the windshield glass C2 of the vehicle C. Furthermore, the second housing 2 includes at least one button 23 of the micro control unit 132 coupled to the projection module 13 for starting and controlling the projection module 13.

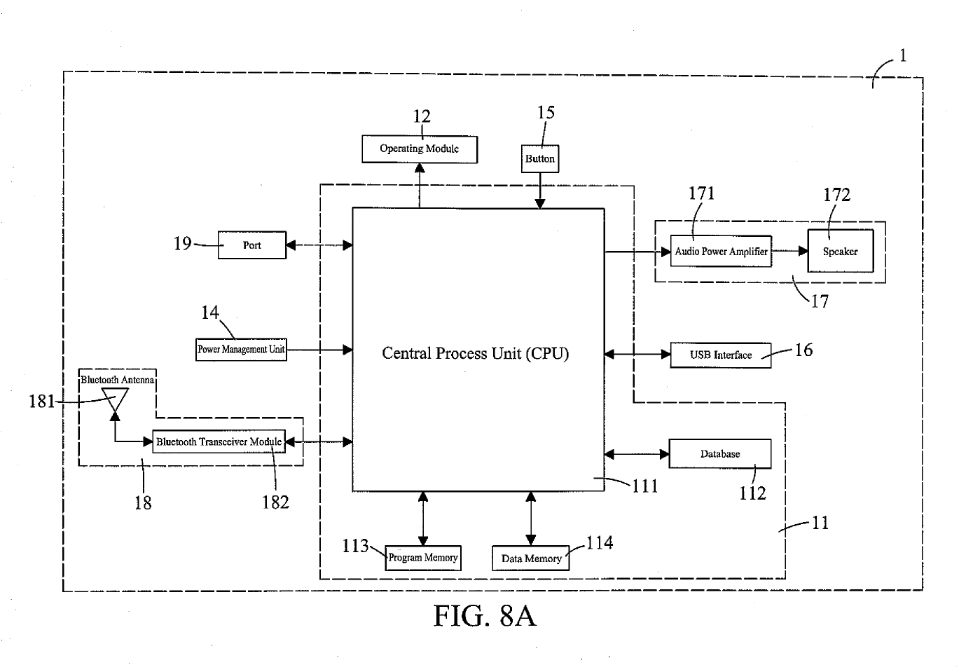

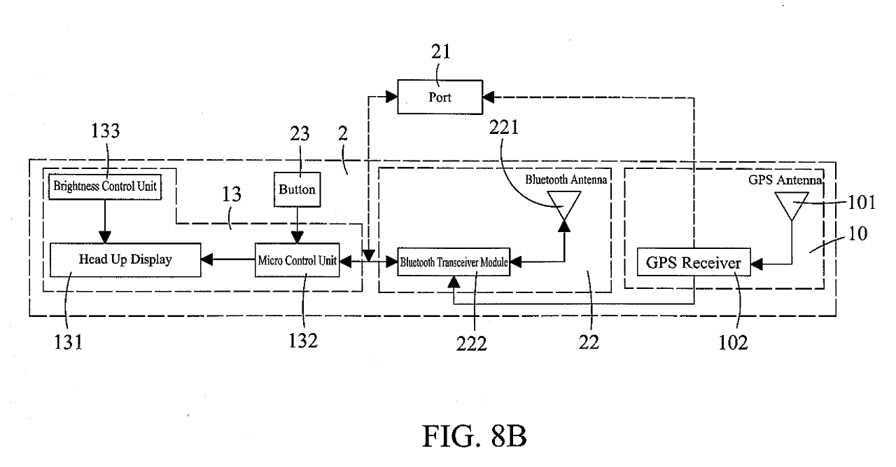

With reference to FIGS. 8A and 8B, a portable navigation device according to a fourth embodiment of the present invention comprises the projection module 13 and the GPS module 10 that is received in the second housing 2 independently from other modules received in the first housing 1. The elements between the first and second housings 1, 2 are transmitted information to/with each other in the forgoing wired or wireless manner.

It can be clearly seen from the preceding accounts on the features of the present invention that the portable navigation device of the present invention has the following advantages:

1. The portable navigation device may project the easy navigation information, e.g. driving forward directly, making a left turn, making a right turn, and the like turning symbols or distance numbers to the predetermined position of the windshield glass for being read by the driver directly. On the other hand, the auxiliary navigation information, such as the about-to-turn road name may be heard by the driver in a voice manner, maintaining the driver's attention.

2. The portable navigation device may display navigation information or mobile information by switching double modes alternatively. For example, the navigation information is projected in the navigation mode easily, and the navigation mode is switched to the common mode automatically for providing the mobile information of the vehicle, e.g. coordinates of longitude and latitude, height, driving direction and speed, and the like positioning information. In addition, the mobile information is transmitted to and shared with other wireless devices by matching with the wireless transceiver module.

3. The portable navigation device is portable and installed easily.

While we have shown and described various embodiments in accordance with the present invention, it should be clear to those skilled in the art that further embodiments may be made without departing from the scope of the present invention.

What is claimed is:

1. A portable navigation device comprising
a GPS module being provided to receive the positioning signals which are transmitted from satellites;
a data manipulation module being used to process the positioning signals received from said GPS module, and at least including a central process unit and a database, said central process unit being coupled to said GPS module, and said database being applied to store the information of map, navigation software;
an operating module being coupled with said central process unit, and including a panel for setting the navigation data of the destination and the functions of the navigating software;
a projection module being coupled with said central process unit, and including a head up display for displaying the mobile information of a vehicle in a common mode or the easy navigation information in a navigation mode, and then the mobile or the navigation information being projected onto said projection member of a windshield glass of said vehicle.

2. The portable navigation device as claimed in claim 1, wherein all said modules are received in a first housing, and said operating module is fixed on one side of said first housing opposite to the driver, and said projection module is attached on another side of said first housing opposite to said windshield glass.

3. The portable navigation device as claimed in claim 1, wherein said projection module is received in a second housing independently from other modules received in said first housing, and each of said first and second housings includes a port for connecting with a connecting cord correspondingly, such that the mobile or the navigation information is transmitted to said projection module and then projected onto said windshield glass of said vehicle through said connecting cord.

4. The portable navigation device as claimed in claim 1, wherein said projection module is received in a second housing independently from other modules received in said first housing, and each of said first and second housings includes a wireless transceiver module so that the mobile or the navigation information is transmitted to said projection module in a wireless manner and then projected onto said windshield glass of said vehicle.

5. The portable navigation device as claimed in claim 1, wherein said projection module and said GPS module are received in said second housing independently from other modules received in said first housing, and each of said first and second housings includes a port for connecting with a connecting cord so that the mobile or the navigation information is transmitted to said projection module through said connecting cord and then projected onto said windshield glass of said vehicle.

6. The portable navigation device as claimed in claim 1, wherein said projection module and said GPS module are received in said second housing independently from other modules received in said first housing.

7. The portable navigation device as claimed in claim 1, wherein each of said first and second housings includes a wireless transceiver module so that the mobile or the navigation information is transmitted to said projection module in a wireless manner and then projected onto said windshield glass of said vehicle.

8. The portable navigation device as claimed in claim 1, wherein said GPS module includes a GPS antenna for receiving satellite signals and a GPS receiver.

9. The portable navigation device as claimed in claim 1, wherein the mobile information of the vehicle contains coordinates of longitude and latitude, height, driving direction and speed.

10. The portable navigation device as claimed in claim 1, wherein the easy navigation information contains driving forward directly, making a left turn, making a right turn, the turning symbols and distance numbers.

11. The portable navigation device as claimed in claim 1 further comprising a power management unit coupled to said central process unit, and including at least one chargeable battery for controlling the operation of the circuit of said portable navigation device including standby, power supply, and charge.

12. The portable navigation device as claimed in claim 1 further comprising at least one button coupled to said central process unit for starting and controlling said portable navigation device.

13. The portable navigation device as claimed in claim 11 further comprising at least one USB interface coupled to said central process unit for connecting with a computer and for charging battery.

14. The portable navigation device as claimed in claim 1 further comprising an indication unit coupled to said central process unit for further indicating the auxiliary navigation information in a voice manner in the navigation mode.

15. The portable navigation device as claimed in claim 14, wherein the auxiliary navigation information includes an about-to-turn road name.

16. The portable navigation device as claimed in claim 14, wherein said indication unit includes an audio power amplifier and a speaker.

17. The portable navigation device as claimed in claim 14 further comprising a wireless transceiver module including a bluetooth antenna and a bluetooth transceiver module for transmitting the positioning signals of the satellites to other wireless devices or for transmitting the voice navigation information to a wireless earphone.

18. The portable navigation device as claimed in claim 1, wherein said data manipulation module further includes at least one program memory coupled to said central process unit.

19. The portable navigation device as claimed in claim 18, wherein said program memory is a flash memory.

20. The portable navigation device as claimed in claim 1, wherein said data manipulation module further includes at lease one a data memory coupled to said central process unit.

21. The portable navigation device as claimed in claim 20, wherein said data memory is a SDRAM memory.

22. The portable navigation device as claimed in claim 1, wherein said data manipulation module includes a database stored in a removable storage card so as to be updated by removing said removable storage card.

23. The portable navigation device as claimed in claim 22, wherein said central process unit of said data manipulation module is further coupled with a read interface, so as to read the data stored in said removable storage card.

24. The portable navigation device as claimed in claim 1, wherein said panel of said operating module is a touch panel.

25. The portable navigation device as claimed in claim 1, wherein said projection module further includes a micro control unit and a brightness
